(19) United States
(12) Patent Application Publication
(10) Pub. No.: US 2004/0156558 A1
(43) Pub. Date: Aug. 12, 2004

(54) Image warping method and apparatus thereof

(76) Inventor: Sang Yeon Kim, Gyeonggi-do (KR)

Correspondence Address: BIRCH STEWART KOLASCH & BIRCH, PO BOX 747, FALLS CHURCH, VA, 22040-0747, US

(21) Appl. No.: 10/769,802

(22) Filed: Feb. 3, 2004

(30) Foreign Application Priority Data
Feb. 4, 2003 (KR) P2003-6730

(51) Int. Cl. G06K 9/36

(52) U.S. Cl. 382/276

(57) ABSTRACT

Disclosed is an image warping method and apparatus thereof, by which simplified scanline algorithm is implemented by a backward transformation method with minimized implementation costs and which enables to correct image distortion of a display device such as projection TV, projector, monitor, and the like due to optical or mechanical distortion. The present invention implements scanline algorithm as follows. After a position ‘u’ of the source image has been found using the value of ‘x’ of the target image, data of the position ‘u’ of the source image is mapped to a position ‘x’ of the target image. After a position ‘v’ of the source image has been found using the values of ‘x’ and ‘y’ of the target image, data of the position ‘v’ is brought to be mapped to a position ‘y’ of the target image.

This application claims the benefit of the Korean Application No. P2003-6730 filed on Feb. 4, 2004, which is hereby incorporated by reference.

### BACKGROUND OF THE INVENTION

1. Field of the Invention

The present invention relates to a display device, and more particularly, to an image warping method and apparatus thereof, by which image distortion is corrected.

2. Discussion of the Related Art

Generally, when optical or mechanical distortion is caused to such a display device as TV, projector, monitor, and the like, image warping uses spatial transformation for correcting the distortion. Image warping systems can be classified into the following three kinds.

1) Classification according to Transformation Range: Global Transformation Method; and Local Transformation Method

If coordinates of source image and target image are expressed by (u, v) and (x, y), respectively, the source image is represented by the target image, as shown in FIG. 1A, according to the global transformation method or the other target image, as shown in FIG. 1B, according to the local transformation method.

Specifically, the global transformation method determines spatial transformation positions of all pixels in the image through a polynomial equation expressed by global parameters. Hence, the global transformation method has poor diversities but enables to provide smooth spatial transformation performance without discontinuity using less parameters.

On the other hand, the local transformation method is performed using a polynomial equation including separate parameters for each local area of the image. Hence, post-processing is needed since discontinuity may occur at a boundary between the local areas. And, the local transformation method needs more parameters than the global transformation method since separate parameters should be used for each local area. Yet, the local transformation method is more advantageous in the transformation diversities than the global transformation method.

2) Classification According To Transformation Direction: Forward Mapping Method; and Backward Mapping Method

A forward mapping method, as shown in FIG. 2, is expressed by a transformation relation equation that sets coordinates of the source image as independent variables and those of the target image as dependent variables, whereas the backward mapping method is expressed by another relation equation that sets the coordinates of the target image as independent variables and those of the source image as dependent variables.

In this case, since the forward mapping method maps the respective pixels of the source image to the target image, some of the pixels of the target image fail to be mapped (hole generation) or are multiply mapped (multiple mapping). To compensate such problems, post-processing such as filtering is needed. That's why the backward mapping method is widely used.

3) Classification according to Separability: Separable Method; and Non-separable Method

Image warping is a sort of two-dimensional spatial coordinate transformation, and is a non-separable algorithm in horizontal and vertical directions, generally. Yet, many two-dimensional transformations can be replaced by continuous linear transformation using scanline algorithm (Catmull, Edwind and Alvy Ray Smith, 3-D Transformations of Images in Scanline Order, Computer Graphics, (SIGGRAPH '80 Proceedings), vol. 14, No. 3, pp.279-285, July 1980).

If many two-dimensional transformations can be replaced by continuous linear transformation using scanline algorithm, it can be regarded as separable in wide sense.

FIG. 3 is a block diagram of warping algorithm that is horizontally and vertically separable, i.e., scanline algorithm proposed by Catmull and Smith.

Referring to FIG. 3, a horizontal warping processor 301 receives horizontal scan data and performs warping in a horizontal direction to store the result in a memory 302.

A vertical warping processor 303 vertically scans to read the horizontally warped data stored in the memory 302 and performs warping in a vertical direction to finally output horizontally and vertically warped data.

Namely, in case of horizontally/vertically separable algorithm, data, as shown in FIG. 3, is processed by horizontal and vertical scanning so that a line memory is not needed. Moreover, easy data access from memory enables efficient memory control.

In doing so, processing orders of horizontal/vertical warping can be switched. Namely, Catmull and Smith have proposed scanline algorithm of forward mapping functions, which is briefly explained as follows.

First of all, spatial transformation by the forward mapping is expressed by Equation 1.

[x,y]=T(u,v)=[X(u,v), Y(u,v)], [Equation 1]

where a function T indicates a forward transformation function and functions X and Y represent the function T divided by horizontal and vertical coordinates, respectively.

Hence, once the function T is expressed by T(u, v)=F(u)G(v), the function T is separable. In this case, functions F and G are called 2-pass functions. This is because the functions F and G are handled in first and second steps, respectively to complete the spatial transformation.

However, a general spatial transformation function is non-separable. So, the functions F and G become a function of (u, v). Namely, T(u, v)=F(u, v)G(u, v).

For this, Catmull and Smith has proposed the following 2-pass algorithm to scanline-process the non-separable function.

First of all, if I_{src}, Iᵢₙₜ, and I_{tgt} are source image, intermediate image, and target image, respectively, 2-pass algorithm can be expressed by the following three steps.

1^{st} Step: Assuming that vertical coordinate v of source image is constant, a horizontal scanline function can be defined as Fᵥ(u)=X(u, v). By performing coordinate transformation expressed by Equation 2 in a horizontal direction using the mapping function, horizontally warped intermediate image Iᵢₙₜ is made.

I_{src}(x,v)=Iᵢₙₜ(Fᵥ(u),v)=I_{tgt}(u,v) [Equation 2]

Namely, by leaving ‘v’ as assumed constant, data of u position of source image is mapped to x position of intermediate image.

2^{nd} Step: The intermediate image prepared by 1^{st} step is represented by (x, v) coordinates. In doing so, since the intermediate image expressed by (u, v) coordinates are needed for horizontal processing, an auxiliary function Hₓ(v) is driven by adjusting x=X(u, v) of Equation 1 for ‘U’ by leaving ‘x’ as constant. Namely, as u=Hₓ(v), it is represented by a function of ‘v’. In this case, the auxiliary function Hₓ(v) is usually not expressed as a closed form. In such a case, such a numerical method as Newton-Raphson iteration method is needed to solve the equation.

3rd Step: A vertical scanline function is defined as follows using the auxiliary function. As Gₓ(v)=Y(Hₓ(v), v), a function of ‘v’ only is prepared. So, warping can be executed in a vertical direction. Namely, coordinate transformation expressed by Equation 3 is executed by scanning the intermediate image in a vertical direction using the mapping function of the variable v, i.e., Gₓ(v)=Y(Hₓ(v), v), thereby providing the horizontally/vertically warped target image I_{tgt}.

I_{tgt}(x,y)=I_{tgt}(x,Gₓ(v))=Iᵢₙₜ(x,v) [Equation 3]

In this case, the most difficult work in implementing the scanline algorithm is to seek the auxiliary function of the 2nd step since it is generally unable to find an auxiliary function expression of closed form.

Hence, in U.S. Pat. No. 5,204,944 (George Wolberg, Terrance E. Boult, Separable Image Warping Methods and Systems Using Spatial Lookup Tables), disclosed is a method of implementing the above-explained scanline algorithm for the local transformation method and the forward transformation method. In this case, input coordinates are simultaneously re-sampled together with image data using a lookup table to solve the problem of finding the auxiliary function.

However, the above method needs excessive hardware for re-sampling coordinates. Moreover, as mentioned in the foregoing description of the forward transformation method, mapping failure (hole generation) or multiple mapping of the target image pixels may occur. Hence, the forward transformation method needs separate post-processing to raise algorithm complexity, thereby increasing implementation costs.

### SUMMARY OF THE INVENTION

Accordingly, the present invention is directed to an image warping method and apparatus thereof that substantially obviates one or more problems due to limitations and disadvantages of the related art.

An object of the present invention is to provide an image warping method and apparatus thereof, by which simplified scanline algorithm is implemented by a backward transformation method with minimized implementation costs and which enables to correct image distortion of a display device such as projection TV, projector, monitor, and the like due to optical or mechanical distortion.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an image warping method according to the present invention includes a step (a) of, if coordinates of source and target images are defined as (u, v) and (x, y), respectively, driving an auxiliary function by finding a solution of the coordinate y of the target image by leaving the coordinate v of the source image as constant, a step (b) of preparing a horizontally warped intermediate image by applying the auxiliary function to a first backward mapping function u=U(x, y), and a step (c) of preparing a horizontally/vertically warped target image by applying the horizontally warped intermediate image to a second backward mapping function v=V(x, y).

In this case, the step (b) includes a step (d) of finding the coordinate u of the source image by receiving to apply a value of the coordinate x of the target image, polynomial coefficient(s) of the first backward mapping function, and the auxiliary function to the first backward mapping function and a step (e) of preparing the horizontally warped intermediate image by interpolating data of the coordinate u found in the step (d).

And, the step (c) includes a step (f) of applying the second backward mapping function to the intermediate image, a step (g) of finding the coordinate v of the source image by receiving to apply values of the coordinates x and y of the target image, polynomial coefficient(s) of the first backward mapping function, and a result applied in the step (f) to the second backward mapping function, and a step (h) of preparing a horizontally/vertically warped target image by interpolating data of the coordinate v found in the step (g).

In another aspect of the present invention, an image warping method includes a step (a) of, if coordinates of source and target images are defined as (u, v) and (x, y), respectively, driving an auxiliary function (y=Hᵥ (x)) from a backward mapping function v=V(x, y) by finding a solution of the coordinate y of the target image by leaving the coordinate v of the source image as constant, a step (b) of preparing a horizontally warped intermediate image by applying the auxiliary function (y=Hᵥ (x)) to a backward mapping function u=U(x, y), and a step (c) of preparing a horizontally/vertically warped target image by applying the horizontally warped intermediate image to the backward mapping function v=V(x, y).

In another aspect of the present invention, an image mapping apparatus includes a horizontal warping processing unit providing a horizontally warped intermediate image, if coordinates of source and target images are defined as (u, v) and (x, y), respectively, by receiving a value of the coordinate x of the horizontally scanned target image and coefficients b₀₀˜b₂₁ of a polynomial, by finding a solution of the coordinate y of the target image by leaving v as constant to drive an auxiliary function (y=Hᵥ(x)), and by applying the auxiliary function (y=Hᵥ(x)) to a backward mapping function u=U(x, y), a memory storing the horizontally warped intermediate image of the horizontal warping processing unit, and a vertical warping processing unit providing a horizontally/vertically warped target image by scanning the horizontally warped intermediate image stored in the memory in a vertical direction and by applying the scanned image to a backward mapping function v=V(x, y).

In this case, the horizontal warping processing unit includes a first auxiliary function computing unit driving the auxiliary function (i.e., Ay²+By+C=0) by receiving the value of the coordinate x of the horizontally scanned target image and the coefficients b₀₀˜b₂₁ of the polynomial and by adjusting backward mapping function for y by leaving v as constant, a second auxiliary function computing unit finding a solution (y=Hᵥ(x)) for the auxiliary function, a u-coordinate computing unit finding the coordinate u of the source image by receiving the coordinate x of the target image, coefficients a₀₀˜a₂₁ of the polynomial, and a value of y for the auxiliary function, an address and interpolation coefficient detecting unit outputting an integer part uᵢₙₜ of the coordinate u as an address assigning a data-read position in the memory and a fraction part (a=u−uᵢₙₜ) as an interpolation coefficient, and an interpolation unit interpolating data I_{src}(uᵢₙₜ, v) of the source image outputted from the memory with the interpolation coefficient a to output the interpolated data as the intermediate image Iᵢₙₜ(x, v).

And, the vertical warping processing unit includes a v-coordinate computing unit finding the coordinate v of the source image by scanning the intermediate image stored in the memory and by receiving x and y of the target image and the coefficients b₀₀˜b₂₁ of the polynomial, an address and interpolation coefficient detecting unit outputting an integer part vᵢₙₜ of the coordinate v as an address assigning a data-read position in the memory and a fraction part a (a=v−vᵢₙₜ) as an interpolation coefficient, and an interpolation unit outputting the target image I_{tgt}(x, y) by interpolating data Iᵢₙₜ(x, vᵢₙₜ) of the intermediate image outputted from the memory with the interpolation coefficient a outputted from the address and interpolation coefficient detecting unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A and FIG. 1B are diagrams of global and local transformation methods of image warping, respectively;

FIG. 2 is a diagram of forward and backward mapping methods of image warping;

FIG. 3 is a block diagram of warping algorithm that is horizontally and vertically separable;

FIGS. 4A to 4H are diagrams of distortion types existing on a general display device;

FIG. 5 is a block diagram of a horizontal warping processor according to the present invention;

FIG. 6 is a block diagram of a vertical warping processor according to the present invention; and

FIG. 7 is a diagram of a bilinear interpolation method according to the present invention.

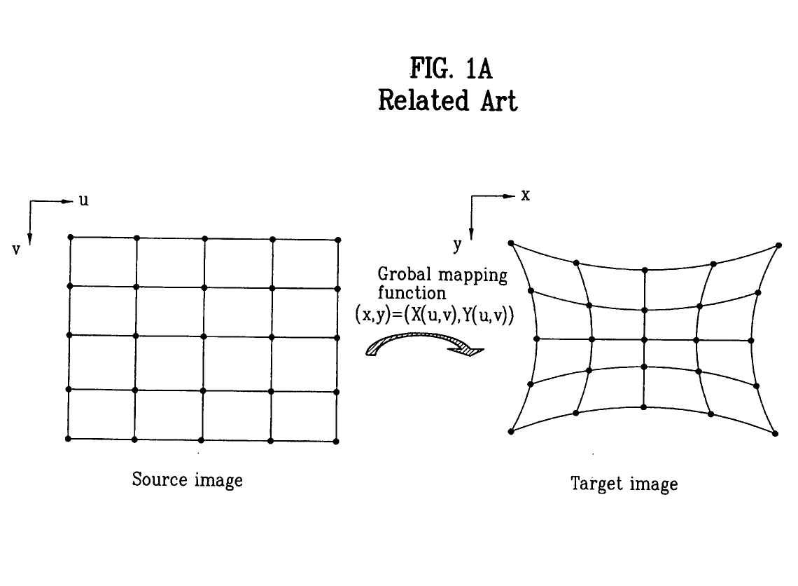

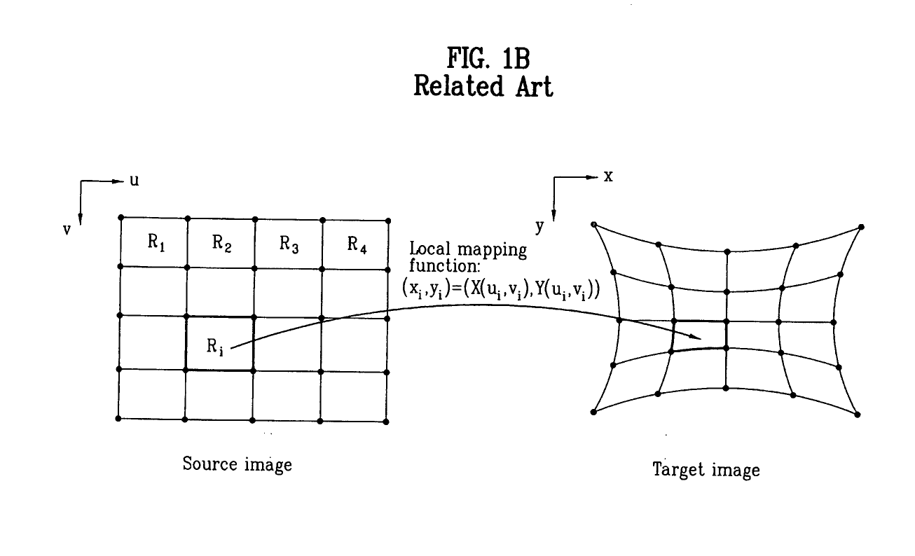

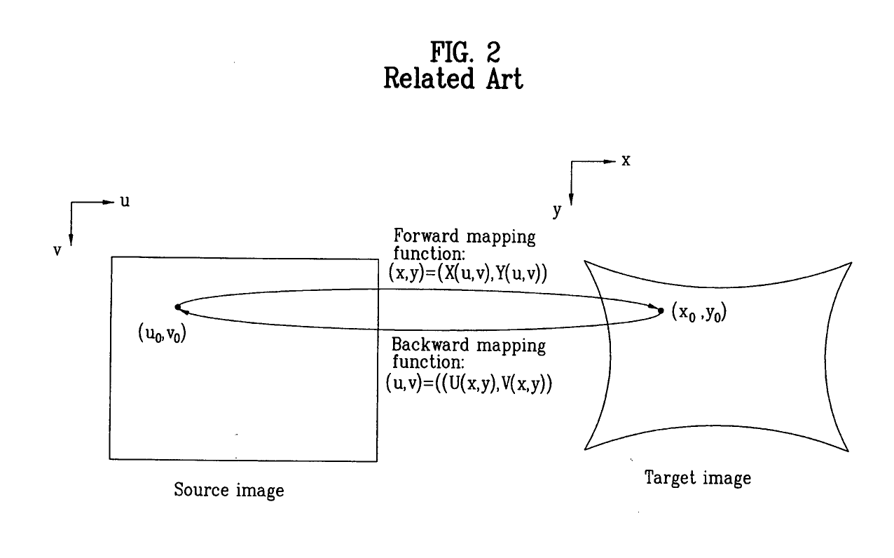

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Geometrical spatial transformation is generally needed to correct image distortion caused to an image display device by optical or mechanical factors. In this case, when coordinates of source and target images are expressed by (u, v) and (x, y), respectively, a backward mapping function used for spatial transformation has such a polynomial form as Equation 4.

$$\begin{matrix}u = U ( x , y ) = {\sum }_{i = 0}^{N} {\sum }_{j = 0}^{N - i} {a}_{ij} {x}^{i} {y}^{j} \\ v = V ( x , y ) = {\sum }_{i = 0}^{N} {\sum }_{j = 0}^{N - i} {b}_{ij} {x}^{i} {y}^{j}\end{matrix} , \qquad [ Equation 4 ]$$

where aᵢ and bᵢ are coefficients of polynomial, respectively and N indicates an order of polynomial.

In this case, there exist more distortion types as the order of the polynomial increases. Yet, as the coefficient of the polynomial increases, algorithm complexity and implementation costs are raised.

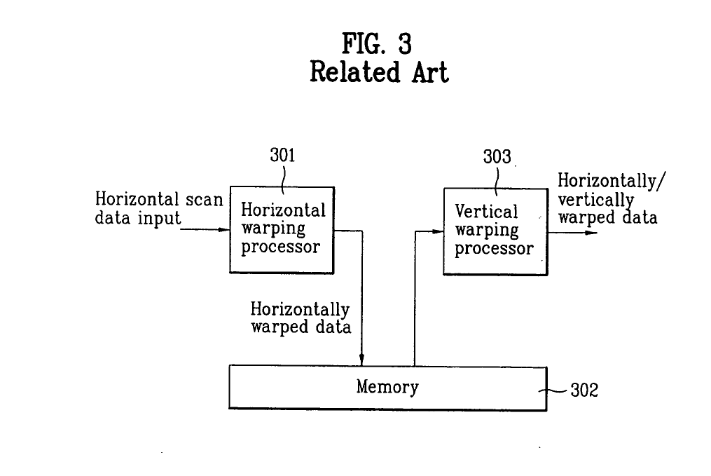

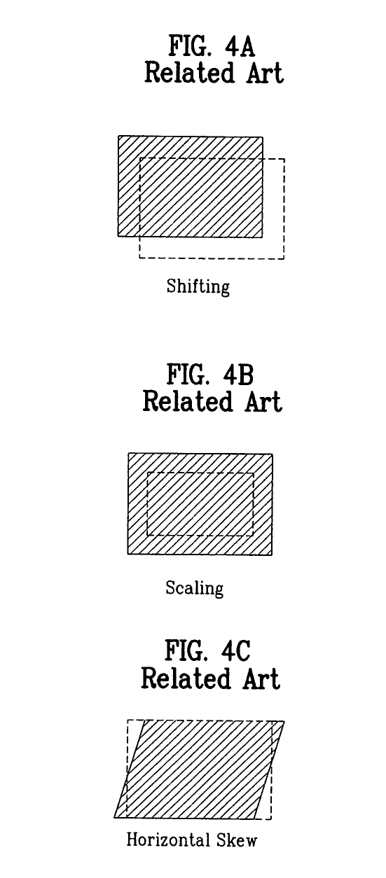

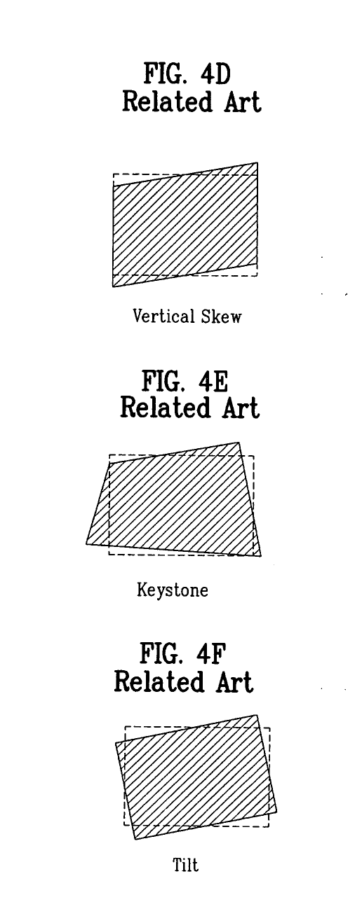

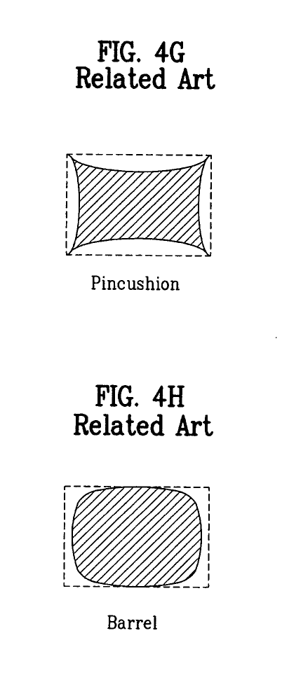

And, the distortion types appearing on the display device are shown in FIGS. 4A to 4H. In this case, correctable distortions are explained according to the order of polynomial as follows.

When the polynomial order is ‘1’, there are shifting (FIG. 4A), scaling (FIG. 4B), horizontal skew (FIG. 4C), vertical skew (FIG. 4D), and tilt (FIG. 4B).

When the polynomial order is ‘2’, there is keystone (FIG. 4E).

When the polynomial order is ‘3’, there are pincushion (FIG. 4G) and barrel (FIG. 4H).

Hence, in order to correct the distortion types shown in FIGS. 4A to 4H, at least cubic polynomial should be used.

Meanwhile, scanline algorithm of a backward mapping function proposed by the present invention is executed by the following three steps.

1^{st} Step: An auxiliary function Hᵥ(x) is driven from v=V(x, y) of Equation 4 by finding a solution for a vertical coordinate ‘y’ of a target image by leaving a vertical coordinate ‘x’ of a source image as constant. Namely, y=Hᵥ(x).

2^{nd} Step: If the auxiliary function Hᵥ(x) found by 1^{st} Step is applied to the first function of Equation 4, u=U(x, Hᵥ(x)), which is represented by a function of ‘x’ only. Using this mapping function, a horizontally warped intermediate image Iᵢₙₜ is provided by Equation 5.

Iᵢₙₜ(x,y)=I_{src}(U(x,Hᵥ(x)),v)=I_{src}(u,v) [Equation 5]

3^{rd} Step: A horizontally/vertically warped image is provided by Equation 6 using the second function, v=V(x, y), of Equation 4 applied to the horizontally warped image of Equation 5.

I_{tgt}(x,y)=Iᵢₙₜ(x,V(x,y))=(x,v) [Equation 6]

Namely, after a position ‘u’ of the source image has been found using the value of ‘x’ of the target image, data of the position ‘u’ of the source image is mapped to a position ‘x’ of the target image. After a position ‘v’ of the source image has been found using the values of ‘x’ and ‘y’ of the target image, data of the position ‘v’ is brought to be mapped to a position ‘y’ of the target image. Hence, horizontally/vertically warped data can be attained. In doing so, the sequence of the horizontal and vertical warping can be switched.

An image warping method, which is implemented from the scanline algorithm proposed by the present invention and the global mapping function expressed by Equation 1, is explained in detail as follows.

First Embodiment

The cubic polynomial developed from Equation 4 is represented by Equation 7.

u=U(x,y)=a₀₀+a₀₁y+a₀₂y²+a₀₃y³+a₁₀x+a₁₁xy+a₂₀xy²+a₂₀x²+a₂₁x²y+a₃₀x³

v=V(x,y)=b₀₀+b₀₁y+b₀₂y²+b₀₃y³+b₁₀x+b₁₁xy+b₁₂xy²+b₂₀x²+b₂₁x²y+b₃₀x³ [Equation 7]

If cubic terms in Equation 7, which are unnecessary for correcting the distortion types shown in. FIGS. 4A to 4H, are removed, a mapping function shortened as Equation 8 is attained.

u=U(x,y)=a₀₀+a₀₁y+a₀₂y²+a₁₀x+a₁₁xy+a₁₂xy²+a₂₀x²+a₂₁x²y

v=V(x,y)=b₀₀+b₀₁y+b₀₂y²+b₁₀x+b₁₁xy+b₁₂xy²+b₂₀x²+b₂₁x²y [Equation 8]

In order to calculate an auxiliary function, if the second one of Equation 8 is adjusted for y by leaving ‘v’ as constant, a quadratic function is represented by Equation 9.

Ay²+By+C=0, where A=b₀₂+b₁₂x, B=b₀₁+b₁₁x+b₂₁x², and C=b₀₀+b₁₀x+b₂₀x²−v. [Equation 9]

Hence, from root formula, ‘y’ of Equation 9 can be driven as Equation 10.

$$y = {H}_{v} ( x ) = \frac{- B \pm \sqrt{{B}^{2} - 4 A C}}{2 A} \qquad [ Equation 10 ]$$

In this case, there may exist three kinds of roots in Equation 10. And, a processing method should vary according to each case.

First of all, if there exist two real roots (B²>4AC), one of two rear roots,

$${y}^{+} = \frac{- B + \sqrt{{B}^{2} - 4 A C}}{2 A} and {y}^{-} = \frac{- B - \sqrt{{B}^{2} - 4 A C}}{2 A} ,$$

is arbitrarily selected to use.

And, in case that there exists one real root (B²=4AC), the root is

$$y = \frac{- B}{2 A} .$$

Moreover, if there exist a pair of imaginary roots (B²<4AC), a pair of the imaginary roots are

$${y}^{+} = \frac{- B + ⅈ \sqrt{{B}^{2} - 4 A C}}{2 A} and {y}^{-} = \frac{- B - ⅈ \sqrt{{B}^{2} - 4 A C}}{2 A} .$$

. In this case, if B²<4AC, since coordinates having imaginary values substantially fail to exist, the imaginary terms of the equation are ignored to provide the same root of the second case that there exists one real root.

After the auxiliary function, y=Hᵥ(x), has been calculated, spatial transformations are horizontally and vertically executed using Equations 5 and 6, respectively. In doing so, since the coordinates mapped by the transformation function are not located at the pixel sample of the source image in general, a pixel value of the mapped coordinates is calculated by interpolation using neighbor pixels.

Specifically, assuming that a center of image is set as an origin of coordinates and that sizes of source and target images are set to W_{src}×H_{src} and W_{tgt}×H_{tgt}, respectively, input coordinates v and x of a horizontal warping processor are integers having ranges of

$$[ \frac{- {H}_{src}}{2} , \frac{{H}_{src}}{2} ] and [ \frac{- {W}_{tgt}}{2} , \frac{{W}_{tgt}}{2} ] ,$$

respectively. And, a coordinate ‘u’ calculated by the horizontal warping processor becomes a real number. In doing so, an integer part uᵢₙₜ is used as an address for assigning a location of data to read from a memory and a fraction part a is used as an interpolation coefficient.

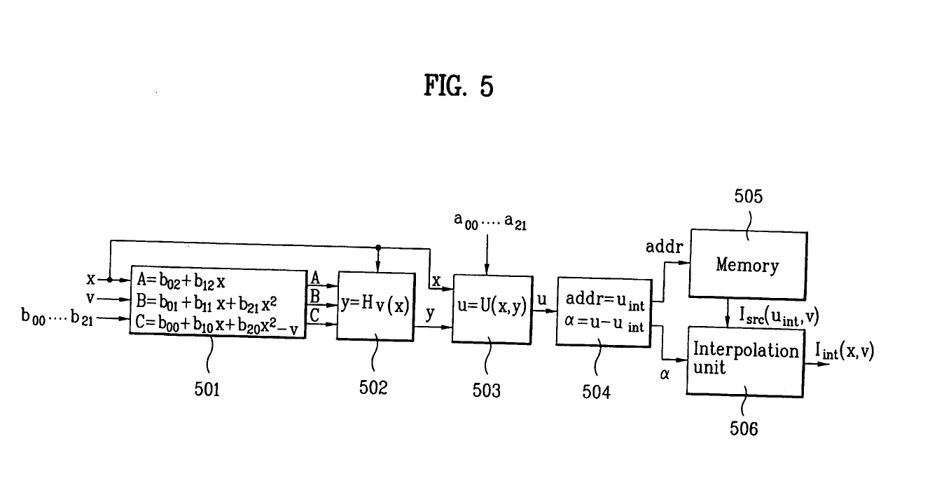

A first auxiliary function computing unit 501, as shown in FIG. 5, of the horizontal warping processor receives ‘x’ of the horizontally scanned target image and coefficients b₀₀˜b₂₁, and adjusts the polynomial for ‘y’ like Equation 9 by leaving ‘v’ as constant to express a quadratic function (i.e., Ay²+By+C=0). And, a second auxiliary function computing unit 502 finds a solution of ‘y’, i.e., auxiliary function, like Equation 10 (y=Hᵥ(x)) using the root formula to output to a u-coordinate computing unit 503.

The u-coordinate computing unit 503 applies the auxiliary function to the first function of Equation 4 to find a coordinate ‘u’ of the source image by receiving ‘x’, a₀₀˜a₂₁, and ‘y’ found by Equation 10, and then outputs the coordinate ‘u’ to an address and interpolation coefficient detecting unit 504.

The address and interpolation coefficient detecting unit 504 outputs the integer part uᵢₙₜ of the coordinate ‘u’ as an address for assigning a location of data to read to a memory 505 and the fraction part (a=u−uᵢₙₜ) as an interpolation coefficient to an interpolation unit 506.

The memory 505 outputs data I_{src}(uᵢₙₜ, v) of the source image stored in the inputted address addr to the interpolation unit 506. And, the interpolation unit 506 interpolates the data I_{src}(uᵢₙₜ, v) of the source image outputted from the memory 505 with the interpolation coefficient a outputted from the address and interpolation coefficient detecting unit 504, thereby outputting the intermediate image Iᵢₙₜ(x, v) like Equation 5.

In this case, since the coordinates mapped by the transformation function of Equation 5 is not located at the pixel sample u of the source image in general, the interpolation unit 506 calculates the pixel value of the mapped coordinates by interpolation using neighbor pixels.

FIG. 7 is a diagram of a method using bilinear interpolation.

Namely, bilinear interpolation in FIG. 7 can be represented by Equation 11.

Iᵢₙₜ(x,v)=(1−a)I_{src}(i,v)+aI_{src}(Uᵢₙₜ−1,V) [Equation 11]

If the horizontal warping image processor in FIG. 5 is firstly operated, the horizontally warped intermediate image is stored in the memory. Thereafter, the intermediate image stored in the memory is scanned in a vertical direction and is then applied to the backward mapping function to provide the horizontally/vertically warped target image, finally.

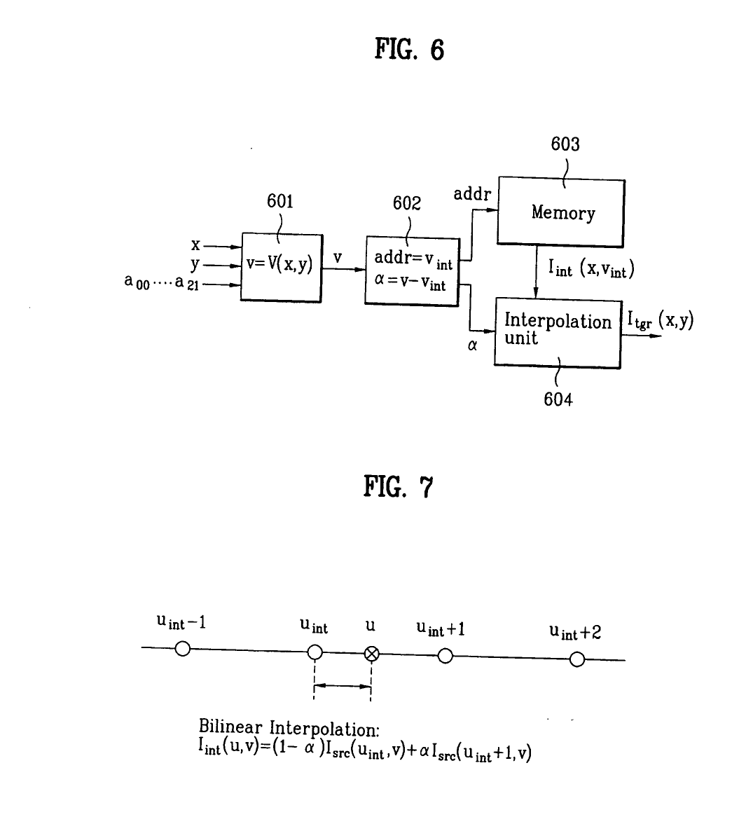

Meanwhile, referring to a vertical warping image processor of FIG. 6, a v-coordinate computing unit 601 scans the intermediate image stored in the memory in a vertical direction, finds the coordinate ‘v’ of the source image by receiving to apply x and y of the target image and the coefficients b₀₀˜b₂₁ of the polynomial to Equation 7, and then outputs the found coordinate ‘v’ to an address and interpolation coefficient detecting unit 602.

The address and interpolation coefficient detecting unit 602 outputs the integer part vᵢₙₜ of the coordinate ‘v’ as an address for assigning a location of data to read to a memory 603 and the fraction part a (a=v−vᵢₙₜ) as an interpolation coefficient to an interpolation unit 604.

The memory 603 outputs data Iᵢₙₜ(x, vᵢₙₜ) of the intermediate image stored in the inputted address addr to the interpolation unit 604. And, the interpolation unit 604 interpolates the data Iᵢₙₜ(x, Vᵢₙₜ) of the intermediate image outputted from the memory 603 with the interpolation coefficient a outputted from the address and interpolation coefficient detecting unit 603, thereby outputting the target image I_{tgt}(x, y) like Equation 6.

Likewise, since the coordinates mapped by the transformation function of Equation 6 is not located at the pixel sample v of the source image in general, the interpolation unit 604 calculates the pixel value of the mapped coordinates by interpolation using neighbor pixels.

Second Embodiment

In the first embodiment of the present invention, the part for computing the auxiliary function needs relatively excessive calculation load and hardware. By adopting small approximation, such calculation load and hardware can be reduced without degrading warping performance.

Namely, in most cases of the quadratic function of Equation 9, ‘A’ is much smaller than ‘B’ or ‘C’. Using such a fact, Equation 9 can be approximated to a linear function of Equation 12.

By+C=0, where B=b₀₁+b₁₁x+b₂₁x² and C=b₀₀+b₁₀x+b₂₀x²−v. [Equation 12]

From the root formula, ‘y’ of Equation 12 can be simply found as Equation 13.

$$y = {H}_{v} ( x ) = \frac{C}{B} \qquad [ Equation 13 ]$$

After the auxiliary function y=Hᵥ(x) has been calculated, horizontal and vertical transformations are executed using Equations 5 and 6.

Accordingly, an image warping method and apparatus thereof according to the present invention enables to implement the simplified scanline algorithm by the backward transformation method with minimized implementation costs and to correct the image distortion, which is caused by optical or mechanical distortion, of a display device such as projection TV, projector, monitor, and the like.

Namely, the present invention adopts the backward mapping method to avoid pixels of non-mapping or multiple mapping, and uses the global transformation method to enable the smooth spatial transformation without discontinuity for the entire image with less parameters. Therefore, the present invention needs no additional post-processing.

And, by adopting the scanline algorithm, the present invention enables the efficient memory access as well as simplified circuit configuration and cost reduction in aspect of hardware implementation. Therefore, the present invention is very competitive in costs and performance when applied to display devices such as projection TV, projector, monitor, etc. to which the correction of image distortion is essential.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An image warping method comprising:
a step (a) of, if coordinates of source and target images are defined as (u, v) and (x, y), respectively, driving an auxiliary function by finding a solution of the coordinate y of the target image by leaving the coordinate v of the source image as constant;
a step (b) of preparing a horizontally warped intermediate image by applying the auxiliary function to a first backward mapping function u=U(x, y); and
a step (c) of preparing a horizontally/vertically warped target image by applying the horizontally warped intermediate image to a second backward mapping function v=V(x, y).

2. The image warping method of claim 1, wherein the first N N-i backward mapping function
$$u = U ( x , y ) = {\sum }_{i = 0}^{N} {\sum }_{j = 0}^{N - i} {a}_{ij} {x}^{i} {y}^{j} ,$$
where aᵢ is a coefficient of a polynomial and N indicates an order of the polynomial.

3. The image warping method of claim 1, wherein the first backward mapping function
$$v = V ( x , y ) = {\sum }_{i = 0}^{N} {\sum }_{j = 0}^{N - i} {b}_{ij} {x}^{i} {y}^{j} ,$$
where bᵢ is a coefficient of a polynomial and N indicates an order of the polynomial.

4. The image warping method of claim 1, the step (b) comprising:
a step (d) of finding the coordinate u of the source image by receiving to apply a value of the coordinate x of the target image, polynomial coefficient(s) of the first backward mapping function, and the auxiliary function to the first backward mapping function; and
a step (e) of preparing the horizontally warped intermediate image by interpolating data of the coordinate u found in the step (d).

5. The image warping method of claim 1, the step (c) comprising:
a step (f) of applying the second backward mapping function to the intermediate image;
a step (g) of finding the coordinate v of the source image by receiving to apply values of the coordinates x and y of the target image, polynomial coefficient(s) of the first backward mapping function, and a result applied in the step (f) to the second backward mapping function; and
a step (h) of preparing a horizontally/vertically warped target image by interpolating data of the coordinate v found in the step (g).

6. An image warping method comprising:
a step (a) of, if coordinates of source and target images are defined as (u, v) and (x, y), respectively, driving an auxiliary function (y=Hv (x)) from a backward mapping function v=V(x, y) by finding a solution of the coordinate y of the target image by leaving the coordinate v of the source image as constant;
a step (b) of preparing a horizontally warped intermediate image by applying the auxiliary function (y=Hv (x)) to a backward mapping function u=U(x, y); and
a step (c) of preparing a horizontally/vertically warped target image by applying the horizontally warped intermediate image to the backward mapping function v=V(x, y).

7. The image warping method of claim 6, the step (a) comprising:
a step (d) of, if the backward mapping functions are u=U(x,y)=a₀₀+a₀₁y+a₀₂y²+a₁₀x+a₁₁xy+a₁₂xy²+a₂₀x²+a₂₁x²y and v=V(x,y)=b₀₀+b₀₁y+b₀₂y²+b₁₀x+b₁₁xy+b₁₂xy²+b₂₀x²+b₂₁x²y, respectively, adjusting the backward mapping functions for y by leaving v of v=V(x, y) as constant to be represented by a quadratic function of Ay²+By+C=0 wherein A=b₀₂+b₁₂x, B=b₀₁+b₁₁x+b₂₁x², and C=b₀₀+b₁₀x+b₂₀x²−v; and
a step (e) of outputting the auxiliary function
$$( y = {H}_{v} ( x ) = \frac{- B \pm \sqrt{{B}^{2} - 4 A C}}{2 A} )$$
by finding a value of y of the quadratic function from a root formula.

8. The image warping method of claim 7, wherein there exist two real roots if B²>4AC and wherein one of the two-rear roots,
$${y}^{+} = \frac{- B + \sqrt{{B}^{2} - 4 A C}}{2 A} and {y}^{-} = \frac{- B - \sqrt{{B}^{2} - 4 A C}}{2 A} ,$$
is arbitrarily selected to be outputted as the auxiliary function in the step (e).

9. The image warping method of claim 7, wherein there exists one real root
$$( y = \frac{- B}{2 A} )$$
if B²=4AC and wherein
$$y = \frac{- B}{2 A}$$
is outputted as the auxiliary function in the step (e).

10. The image warping method of claim 7, wherein there exist a pair of imaginary roots if B 2<4AC and wherein
$$y = \frac{- B}{2 A}$$
is outputted as the auxiliary function in the step (e) since coordinates having imaginary values substantially fail to exist.

11. The image warping method of claim 6, the step (a) comprising:
a step (f) of, if the backward mapping functions are u=U(x,y)=a₀₀+a₀₁y+a₀₂y²+a₁₀x+a₁₁xy+a₁₂xy²+a₂₀x²+a₂₁x²y and v=V(X,y)=b₀₀+b₀₁y+b₀₂y²+b₁₀x+b₁₁xy+b₁₂xy²+b₂₀x²+b₂₁x²y, respectively, adjusting the backward mapping functions for y by leaving v of v=V(x, y) as constant to be represented by a linear function of By+C=0 wherein B=b₀₁+b₁₁x+b₂₁x², and C=b₀₀+b₁₀x+b₂₀x²−v; and
a step (g) of outputting the auxiliary function
$$( y = {H}_{v} ( x ) = \frac{C}{B} )$$
by finding a value of y of the linear function.

12. The image warping method of claim 6, the step (b) comprising:
a step (h) of finding the coordinate u of the source image by receiving to apply a value of the coordinate x of the target image, coefficients a₀₀˜a₂₁ of a polynomial, and y=Hᵥ(x) of the step (a) to the backward mapping function u=U(x, y); and
a step (i) of preparing the horizontally warped intermediate image Iᵢₙₜ(x, v) by interpolating data of the coordinate u found in the step (h).

13. The image warping method of claim 6, the step (c) comprising:
a step (j) of applying the v=V(x, y) to the intermediate image Iᵢₙₜ(x, v) of the step (b) to find a mapping function Iᵢₙₜ(x, V(x, y));
a step (k) of finding the coordinate v of the source image by receiving to apply values of the coordinates x and y of the target image, coefficients b₀₀˜b₂₁ of a polynomial, and the mapping function Iᵢₙₜ(x, V(x, y)) of the step (j) to the backward mapping function v=V(x, y); and
a step (1) of preparing the horizontally/vertically warped target image I_{tgt}(x, y) by interpolating data of the coordinate v found in the step (k).

14. An image mapping apparatus comprising:
a horizontal warping processing unit providing a horizontally warped intermediate image, if coordinates of source and target images are defined as (u, v) and (x, y), respectively, by receiving a value of the coordinate x of the horizontally scanned target image and coefficients b₀₀˜b₂₁ of a polynomial, by finding a solution of the coordinate y of the target image by leaving v as constant to drive an auxiliary function (y=Hᵥ(x)), and by applying the auxiliary function (y=Hᵥ(x)) to a backward mapping function u=U(x, y);
a memory storing the horizontally warped intermediate image of the horizontal warping processing unit; and
a vertical warping processing unit providing a horizontally/vertically warped target image by scanning the horizontally warped intermediate image stored in the memory in a vertical direction and by applying the scanned image to a backward mapping function v=V(x, y).

15. The image warping apparatus of claim 14, the horizontal warping processing unit comprising:
a first auxiliary function computing unit driving the auxiliary function (i.e., Ay²+By+C=0) by receiving the value of the coordinate x of the horizontally scanned target image and the coefficients b₀₀˜b₂₁ of the polynomial and by adjusting backward mapping function for y by leaving v as constant;
a second auxiliary function computing unit finding a solution (y=Hᵥ(x)) for the auxiliary function;
a u-coordinate computing unit finding the coordinate u of the source image by receiving the coordinate x of the target image, coefficients a₀₀˜a₂₁ of the polynomial, and a value of y for the auxiliary function;
an address and interpolation coefficient detecting unit outputting an integer part uᵢₙₜ of the coordinate u as an address assigning a data-read position in the memory and a fraction part (a=u−uᵢₙₜ) as an interpolation coefficient; and
an interpolation unit interpolating data I_{src}(uᵢₙₜ, v) of the source image outputted from the memory with the interpolation coefficient a to output the interpolated data as the intermediate image Iᵢₙₜ(x, v).

16. The image warping apparatus of claim 15, wherein the interpolation unit is operated by bilinear interpolation using neighbor pixels.

17. The image warping apparatus of claim 14, the vertical warping processing unit comprising:
a v-coordinate computing unit finding the coordinate v of the source image by scanning the intermediate image stored in the memory and by receiving x and y of the target image and the coefficients b₀₀˜b₂₁ of the polynomial;
an address and interpolation coefficient detecting unit outputting an integer part vᵢₙₜ of the coordinate v as an address assigning a data-read position in the memory and a fraction part a (a=v−vᵢₙₜ) as an interpolation coefficient; and
an interpolation unit outputting the target image I_{tgt}(x, y) by interpolating data Iᵢₙₜ(x, vᵢₙₜ) of the intermediate image outputted from the memory with the interpolation coefficient a outputted from the address and interpolation coefficient detecting unit.
